(19) United States
(12) Patent Application Publication
(10) Pub. No.: US 2025/0250747 A1
(43) Pub. Date: Aug. 7, 2025

(54) SYSTEMS AND METHODS FOR CRACK REPAIR IN RECREATIONAL COURT SURFACES

(71) Applicants: Horace Caldwell Robinson, JR., Alpharetta, GA (US); Charles Bradford Carroll, Canton, GA (US)

(72) Inventors: Horace Caldwell Robinson, JR., Alpharetta, GA (US); Charles Bradford Carroll, Canton, GA (US)

(21) Appl. No.: 18/432,490

(22) Filed: Feb. 5, 2024

(51) Int. Cl. E01C 11/00; C09J 5/00; C09J 7/29; C09J 7/38

(52) U.S. Cl. CPC E01C 11/005; C09J 5/00; C09J 7/29; C09J 7/381; C09J 2301/124; C09J 2301/162; C09J 2400/263; C09J 2415/006; C09J 2423/00

(57) ABSTRACT

Provided are systems and methods for repairing cracks in a paved surface. In one embodiment, a system can include a first layer for application over the crack that includes a watertight tape having an adhesive layer on a bottom surface. A first liquid latex-based adhesive is applied atop the first layer, followed by a second layer applied atop the first layer, where the second layer includes a thin polyester textile having a width greater than the first layer. The system can further include a second liquid latex-based adhesive applied atop the second layer that can be the same as or different from the first liquid latex-based adhesive.

### BACKGROUND

Sports courts such as tennis courts, pickleball courts, basketball courts, running tracks, and other multi-use courts are subject to developing cracks. There are two main types of paved sports courts, asphalt and concrete. Cracks are one of the main causes that necessitate resurfacing, especially in asphalt substrate courts. Cracks in paved surfaces, including tennis courts and other sports courts, can occur due to various factors. Courts are susceptible to cracking due to poor drainage or when excessive water accumulation on the court causes the ground to shift and heave, leading to cracks. Exposure to the elements can also cause cracking. Sun, wind, and rain exposure over time can cause the material to degrade, resulting in cracks and holes on the court's surface. Other factors can include tree roots and soil heaving from soil moisture level changes, both of which can cause the ground to rise or settle, leading to bumps and cracks in the court surface.

Cracking can cause courts to need full resurfacing every three to five years. Typically, basic crack repair can leave a court blemish-free through only one winter. Resurfacing is expensive and can result in downtime for court use. More economical and lasting alternatives to existing crack repair systems are needed. These needs and other needs are satisfied by the present disclosure.

### SUMMARY

Embodiments of the present disclosure provide systems and methods for crack repair in paved surfaces.

An embodiment of the present disclosure includes a system for repairing a crack in a paved surface. The system can include a first layer for application over the crack. The first layer can include a watertight tape having an adhesive layer on a bottom surface. The system can further include a first liquid latex-based adhesive applied atop the first layer. The system can further include a second layer applied atop the first layer, where the second layer can include a thin polyester textile having a width greater than the first layer. The system can further include a second liquid latex-based adhesive applied atop the second layer that can be the same as or different from the first liquid latex-based adhesive.

An embodiment of the present disclosure also includes a method for repairing a crack in a paved surface. The method can include applying a watertight tape over a crack in a paved surface to cover the crack to form a first layer, covering the first layer with a thin polyester textile to form a second layer that adheres to the first layer, and impregnating the polyester mat with a liquid latex-based adhesive. The watertight tape can include a polymer modified butyl adhesive on a bottom surface. The second layer can have a width greater than the first layer.

These and other aspects, objects, features, and embodiments will become apparent to a person of ordinary skill in the art upon consideration of the following detailed description of illustrative embodiments exemplifying the best mode as presently perceived.

### BRIEF DESCRIPTION OF THE DRAWINGS

For a more complete understanding of the embodiments and the advantages thereof, reference is now made to the following description, in conjunction with the accompanying figures briefly described as follows:

FIG. 1 is a diagram of the crack repair system according to various example embodiments.

FIG. 2 is a diagram of the crack repair system according to additional example embodiments.

FIGS. 3A-3I are a series of camera images illustrating embodiments of the system as installed on a plexiglass test substrate and measurements of the system components.

FIG. 4 is a flowchart illustrating a method of crack repair according to various example embodiments.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, material science, and the like, which are within the skill of the art.

The following examples are put forth so as to provide those of ordinary skill in the art with a complete disclosure and description of how to perform the methods and use the devices and methods disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise.

### GENERAL DISCUSSION

In accordance with the purpose(s) of the present disclosure, as embodied and broadly described herein, embodiments of the present disclosure, in some aspects, relate to systems and methods for repairing cracks in a paved surface.

In general, embodiments of the present disclosure provide for crack repair in asphalt or concrete surfaces. In particular, the paved surfaces can correspond to recreational sport courts (e.g., tennis, pickleball, racquetball, basketball, running tracks, mixed sport courts, and the like) that include a painted surface. The systems and methods described herein provide for a thin, flexible, and durable crack repair that allows for court refinishing (e.g., paint) to be applied directly over the crack repair without the need for additional materials at the transition edge.

An embodiment of the present disclosure includes a system for repairing a crack in a paved surface. Advantageously, the present system is ultra-thin to minimize a raised lip at the edge of the system, thereby removing the need for additional material at the edges to provide an even transition to the paved surface below. In competitor systems, the crack repair materials are thicker, which creates a raised lip or edge. Fiberglass sheets are installed at these edges to level the underlying surface. The present system and methods of installing remove the need for the additional leveling step and materials, saving time and costs. The crack repair system provided herein is the thinnest known permanent crack repair system. Advantageously, the system will not affect tennis or pickleball ball bounce. Additionally, the crack repair system described herein can last for many years.

The system can include a first layer that is applied over the crack. The first layer can include a watertight tape having an adhesive layer on a bottom surface. The system can further include a first liquid latex-based adhesive applied atop the first layer. The system can further include a second layer applied atop the first layer, where the second layer can include a thin polyester textile having a width greater than the first layer. The system can further include a second liquid latex-based adhesive applied atop the second layer that can be the same as or different from the first liquid latex-based adhesive.

In some embodiments, the watertight tape can be a textile or fabric having an adhesive layer on a bottom surface. The textile can be a polyester-based textile. The adhesive layer can include a polymer-modified butyl adhesive and can be protected by a film backing to protect the adhesive prior to installation. Advantageously, the watertight tape is flexible at temperatures from about −30° F. to about 180° F., or as low as about −31° F. Accordingly, the tape itself is resistant to cracking or shattering even in prolonged extreme temperatures. The watertight tape is thin, having a thickness of about 0.8 mm (about 34 mil), adding minimal bulk over the paved substrate while providing good adhesion and flexibility when the underlying crack may expand or contract during temperature fluctuations. The majority of expansion and contraction of the crack can occur within the flexible, gooey, adhesive without affecting the layers above. The flexibility in the upper layer prevents cracking of paint layers. The flexible, gooey adhesive is much more flexible and has lower tensile strength compared to the top layer. In some embodiments, the watertight tape has a width of about 6 inches. In other embodiments, the watertight tape can have a width sufficient to extend beyond the crack edges by approximately 1 inch to 2 inches on each side. Other widths can be envisioned by one having ordinary skill in the art. In some embodiments, the watertight tape can be a commercially available tape such as GAF™ UNITED COATINGS™ UNITAPE SEAM TAPE or ETERNABOND® WEB SEAL™.

In some embodiments, one or both of the first and second liquid latex-based adhesives can be applied using such as a squeegee, roller, or other methods as would be readily understood by one having ordinary skill in the art.

The liquid latex-based adhesive can have an application rate of about 55 square feet per gallon to about 65 square feet per gallon depending on upon the application method. The viscosity of the adhesive can be tuned during manufacturing based on the intended application method. In one embodiment, the viscosity is controlled in manufacturing and can be from about 2700 centipoise to about 3100 centipoise calculated on a Brookfield viscometer with a #2 spindle at 20 RPM. Alternately, the viscosity may be such as from about 73 Krebs Units to about 77 Krebs Units calculated on a Stormer viscometer.

The liquid latex-based adhesive can include carboxylated styrene butadiene latex. In various embodiments, the adhesive can include a styrene-butadiene based polymer, about 45% to about 55% water, about 0.1 to about 0.4% acrylic associative thickener, and/or about 1% to about 2% urethane thickener. Advantageously, the liquid latex-based adhesive has significantly better adhesion, flexibility, water resistance, and elongation when compared to a “liquid acrylic” adhesive as commonly used. Liquid acrylics dry to form a rigid mat, whereas the latex-based adhesives provided herein allow for greater flexibility.

A thin polyester textile is layered over the watertight tape layer. In some embodiments, the thin polyester textile is applied directly over the watertight tape and the liquid-based adhesive is then applied on top. In other embodiments, an intermediate layer of the liquid latex-based adhesive is applied atop the watertight tape between the watertight tape and the thin polyester textile layer. By including the intermediate liquid latex-based adhesive, air gaps under the thin polyester textile layer can be prevented, and the edges are more securely adhered.

In various embodiments, the thin polyester textile layer is wider than the watertight tape. In a particular embodiment, the watertight tape can be about 6 inches wide and the thin polyester textile can be about 18 inches wide. The larger width of the polyester textile layer provides a smoothing effect over the edges of the watertight tape, effectively eliminating any lipping at the transition edge of the tape layer.

In some embodiments, the thin polyester textile layer is a spun-bonded nonwoven polyester mat. The thin polyester textile layer can have a thickness of about 0.1 mm to about 0.25 mm (about 4 mils to about 10 mils). In a particular embodiment, the thin polyester textile layer can include polyester scrim. ADFORS® BAMILEX roofing fabric is an example of one suitable thin polyester textile layer.

The top side of the thin polyester textile layer can be impregnated with the liquid latex-based adhesive as described above. The polyester textile layer can be impregnated prior to installation or by applying the liquid adhesive after installation of the thin polyester textile layer as described above. When impregnated with the liquid latex-based adhesive, the thin polyester textile layer remains flexible at temperatures above 32° F. and rigid below 32° F. In other membrane crack repair systems that use liquid acrylics, hairline and spider cracking that telegraph through into the top paint layers are a common issue. Such cracking is caused by continued contraction in the substrate after the adhesive has turned rigid and fragile, thereby cracking the adhesive. The point where a latex state changes from a flexible material to a rigid, fragile state is defined as the glass transition temperature (T_{g}). Commonly used liquid acrylics have a T_{g} above 50° F. (10° C.), whereas the T_{g} of the styrene butadiene adhesive described herein is 32° (0° C.). The lower T_{g} allows the membranes to move along with the contraction of the substrate in lower temperatures, reducing or eliminating the hairline and spider cracking.

Owing to the extremely thin layers, the need for fiberglass or other materials to bond or smooth the textile layer to the paved surface is removed. Other crack repair systems and methods are thick, resulting in a raised edge above the court surface that must be filled, bonded, and/or smoothed to provide an even finished playing surface. The presently described system is about 1.3 mm thick at the thickest point in the middle and the thinnest point at the edge has a thickness of not more than 0.3 mm, which is thin enough that there is no discernible edge once a color coating is applied.

The present disclosure also provides for a method for repairing a crack in a paved surface. The method can include applying a watertight tape over a crack in a paved surface to cover the crack to form a first layer, covering the first layer with a thin polyester textile to form a second layer that adheres to the first layer, and impregnating the polyester mat with a liquid latex-based adhesive as described above. The watertight tape can include a polymer modified butyl adhesive on a bottom surface. The second layer can have a width greater than the first layer.

The watertight tape can be a self-adhesive tape as described above. Where the crack has angles or bends, the tape can be cut and applied in abutting segments to ensure that the tape is centered over the crack.

The thin polyester textile can be applied directly over the watertight tape or can be adhered with an intermediate layer of liquid latex-based adhesive as described above. The intermediate layer provides a more secure attachment to the underlying paved surface and prevents air pockets from being trapped under the edges of the textile. The liquid latex-based adhesive can have a setting time of about 10 minutes to about 2 hours, depending on conditions. The thin polyester textile can be slightly repositioned before the adhesive is fully set.

Finally, a coating of liquid latex-based adhesive is applied to the top surface of the thin polyester textile to impregnate it and further adhere the thin polyester textile to the paved surface.

In some embodiments, the crack is cleaned and filled prior to applying the watertight tape. In a particular embodiment, the crack can be filled with a filler material comprising latex, sand, and cement. Other suitable materials can be used as would be appreciated by one of ordinary skill in the art. Other methods employ epoxy-based filler or polyurethane foam to fill cracks. However, the combination of latex, sand, and cement provide a combination of flexibility and strength. The presently described system provides the fastest and most cost-effective method for filling a crack in a sports surface.

Turning now to the drawings, exemplary embodiments are described in detail.

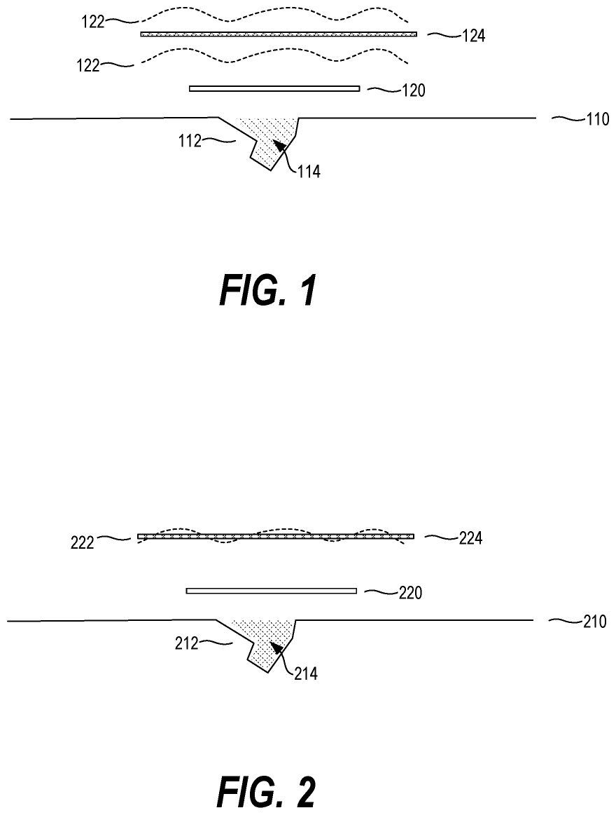

FIG. 1 illustrates one embodiment of the system described above. The system is shown in an exploded view to illustrate the arrangement of the components. Crack 112 in paved surface (or court) 110 is shown filled with a filler 114. A first layer formed from a self-adhesive watertight tape 120 is applied over crack 110. A liquid latex-based adhesive 122 is applied to adhere a second layer 124 formed from a thin textile layer to the underlying first layer 120 and paved surface 110. An application of liquid latex-based adhesive 122 is impregnated into the top of second layer 124. Once cured, a color coating can be applied to the second layer 124. The formulations of the first and second adhesives 122 can be the same or different from one another.

FIG. 2 illustrates another embodiment of the system described above. The system is shown in an exploded view to illustrate the arrangement of the components. Crack 212 in paved surface (or court) 210 is shown filled with a filler 214. A first layer formed from a self-adhesive watertight tape 220 is applied over crack 210. A second layer 224 formed from a thin textile layer applied to the underlying first layer 220. The second layer 224 is wider than the first layer 220 such that the edges of layer 224 can be adhered to paved surface 210. An application of liquid latex-based adhesive 222 (shown with a wavy dashed line) is impregnated into the top of second layer 224. Once cured, a color coating can be applied to the second layer 224.

Table 1 provides thickness measurements for various layers in an example of the system as measured on a plastic substrate for testing purposes. The measurements were taken at the thickest (center portion) of the system using digital calipers and the thickness of the plastic substrate was subtracted from total thickness to obtain the thickness of the system.

TABLE 1
Thickness measurements of the system and its components

| Thickness | inches | mm |
|---|---|---|
| Plastic (test substrate) | 0.208 | 5.2832 |
| Plastic and Tape | 0.247 | 6.2738 |
| Polyester fabric (second layer) | 0.01 | 0.254 |
| Completed system on plastic | 0.259 | 6.578 |
| Tape (first layer) | 0.039 | 0.9906 |
| Completed system | 0.051 | 1.2954 |

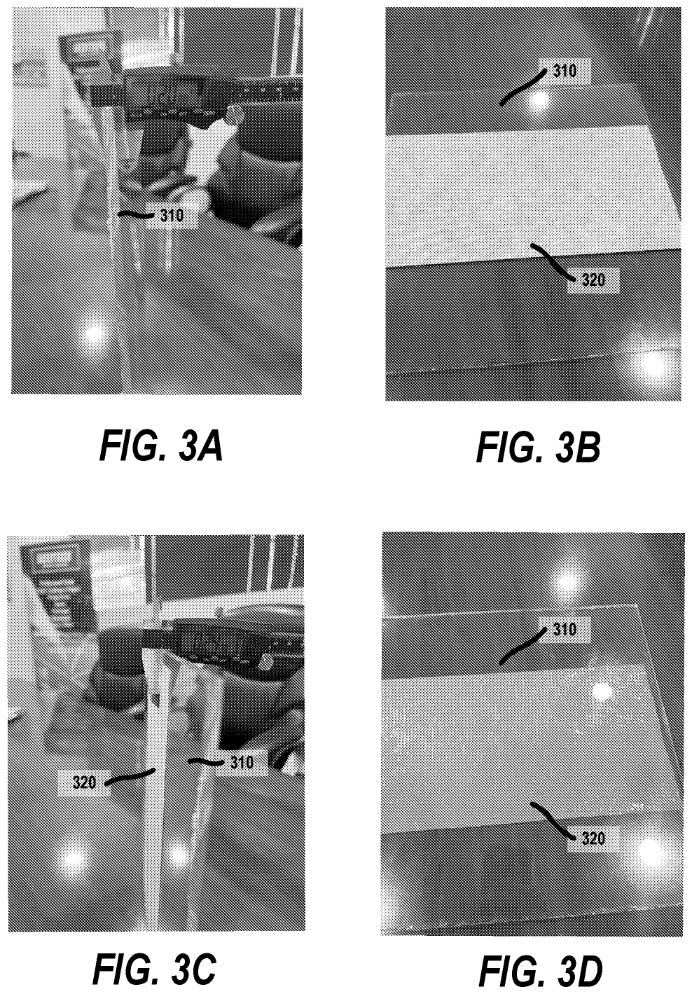

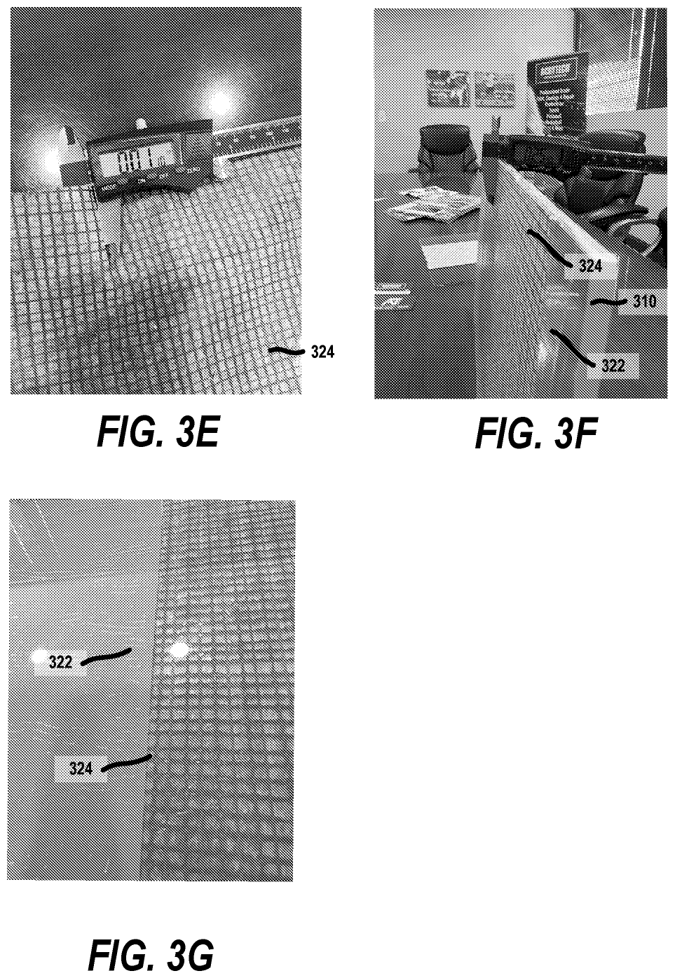

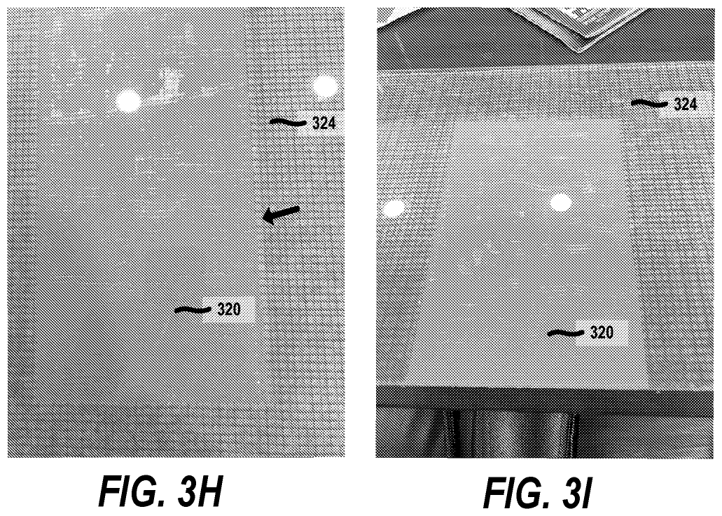

FIGS. 3A-3I illustrate the test described in Table 1. FIG. 3A shows the thickness of the plexiglass test substrate 310, which is measured to be 0.2080 inches in this example. FIG. 3B is a top view of the first layer 320 applied to substrate 310. FIG. 3C is a side view showing the thickness of the combined first layer 320 adhered to substrate 310. FIG. 3D is a view from the underside of FIG. 3B, demonstrating the adherence of the first layer 320 to the substrate 310.

FIG. 3E shows the thickness of the polyester fabric second layer 324, which is measured to be 0.0110 inches in this example before being adhered to the rest of the system. FIG. 3F shows an assembled system on plastic substrate 310, where the second layer 324 has been adhered with an adhesive 322 (not visible) and a second layer of adhesive 322 is impregnated into second layer 324, which demonstrates the thin edge of the system. FIG. 3G is a view from the underside of substrate 310 showing a close-up of the adhered edge of the completed system as shown in FIG. 3F.

FIGS. 3H and 3I are comparisons of two embodiments of the system, taken from the underside of the substrate 310. FIG. 3H does not include the adhesive 322 applied between the first layer 320 and the second layer 324. As indicated by the arrow, when compared to the system in FIG. 3I that includes adhesive 322 applied between the first layer 320 and the second layer 324, the second layer 324 in FIG. 3H is raised at the edge of the first layer 320, indicating that the additional layer of adhesive 322 is beneficial for providing a smoother transition edge.

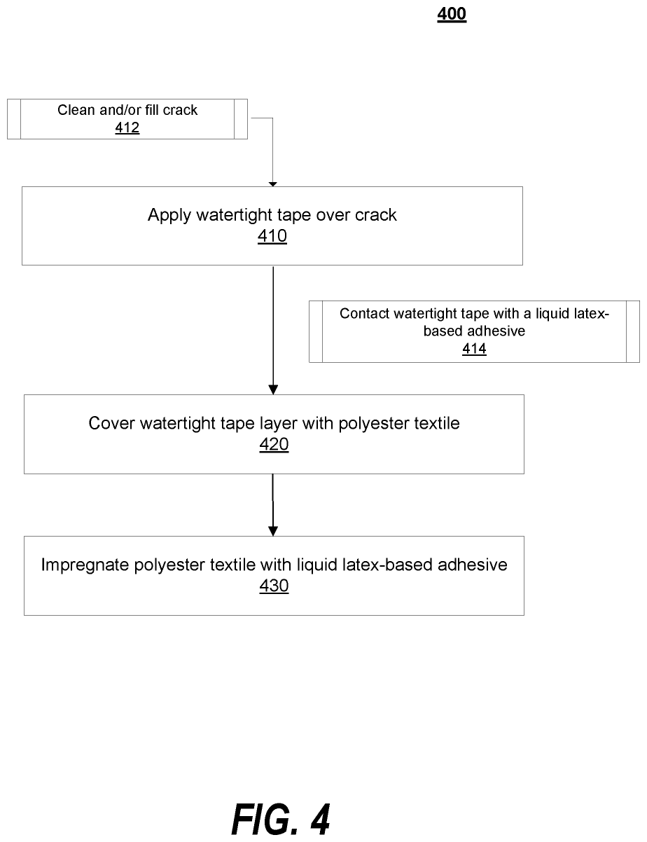

FIG. 4 illustrates a method 400 of crack repair. Although the method diagram illustrates a specific order, some steps may be omitted. Alternatively, two or more steps may be performed, at least in part, at the same time. At step 410, a watertight tape can be applied over the crack. Prior to step 410, a step 412 can be performed to clean and/or fill the crack. At step 420, the watertight tape layer can be covered with a polyester textile or mat. The polyester textile can be wider than the watertight tape layer so that the edges of the watertight tape are overlapped by the polyester textile. An intermediate step 414 can occur between steps 410 and 420, in which a liquid latex-based adhesive is applied to the top surface of the watertight tape, or alternatively to the bottom surface of the polyester textile. This optional step can prevent or reduce air pockets between the two layers. At step 430, the polyester textile is impregnated with liquid latex-based adhesive. The liquid latex-based adhesive in step 430 can be the same or different from the adhesive in step 414.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

Therefore, at least the following is claimed:

1. A system for repairing a crack in a paved surface comprising:
a watertight tape comprising an adhesive layer on a bottom surface, wherein the watertight tape is applied directly over the crack;
a first latex-based adhesive applied atop the watertight tape;
a polyester textile having a width greater than the watertight tape, wherein the polyester textile is applied atop the first latex-based adhesive; and
a second latex-based adhesive applied atop the polyester textile.

2. The system of claim 1, wherein the first latex-based adhesive, the second latex-based adhesive, or both, comprise carboxylated styrene butadiene latex.

3. The system of claim 2, wherein the polyester textile comprises a spun-bonded nonwoven polyester mat.

4. The system of claim 3, wherein the polyester textile has a thickness of about 0.1 mm to about 0.25 mm.

5. The system of claim 1, wherein the polyester textile is impregnated with the second latex-based adhesive.

6. The system of claim 1, wherein the watertight tape comprises a fabric backing on a top surface, and wherein the adhesive layer comprises a polymer-modified butyl adhesive.

7. The system of claim 1, wherein the polyester textile remains flexible at temperatures above about 32° F. and rigid at and below about 32° F.

8. The system of claim 1, wherein the watertight tape has a thickness of about 0.8 mm.

9. The system of claim 1, wherein the system has a center thickness of about 1.3 mm and an edge thickness of about 0.3 mm.

10. A method for repairing a crack in a paved surface, the method comprising:
applying a watertight tape over a crack in a paved surface to cover the crack to form a first layer, wherein the watertight tape comprises a polymer modified butyl adhesive on a bottom surface;
covering the first layer with a polyester textile having a width greater than the first layer to form a second layer that adheres to the first layer; and
impregnating the polyester textile with a liquid latex-based adhesive.

11. The method of claim 10, further comprising contacting the first layer with a liquid latex-based adhesive before covering the first layer with the second layer.

12. The method of claim 10, wherein the liquid latex-based adhesive is a carboxylated styrene butadiene latex adhesive.

13. The method of claim 10, wherein the polyester textile comprises a spun-bonded nonwoven polyester mat reinforced with polyester scrim.

14. The method of claim 10, further comprising at least one of cleaning or filling the crack with a filler prior to applying the first layer.

15. The method of claim 14, wherein the filler comprises an acrylic latex binder blended with silica sand and Portland cement mixture.

16. A system for repairing a crack in a paved surface comprising:
a first layer comprising a watertight tape comprising an adhesive layer on a bottom surface, wherein the first layer is applied over the crack;
a second layer comprising a polyester textile having a width greater than the first layer, wherein the second layer is applied atop the first layer; and
a liquid latex-based adhesive applied atop the second layer.

17. The system of claim 16, further comprising an intermediate layer of liquid latex-based adhesive between the first and second layers.

18. The system of claim 16, wherein the liquid latex-based adhesive comprises liquid carboxylated styrene butadiene latex.

19. The system of claim 16, wherein the polyester textile comprises a spun-bonded nonwoven polyester mat having a thickness of about 0.1 mm to about 0.25 mm.

20. The system of claim 16, wherein the system has a total thickness at a center of about 1.3 mm and an edge thickness of about 0.3 mm.
